(19) United States
(12) Patent Application Publication
(10) Pub. No.: US 2006/0032543 A1
(43) Pub. Date: Feb. 16, 2006

(54) Eductor

(76) Inventors: Barry Hague, Nottinghamshire (GB); Garry William Crossdale, Ripley (GB); Stephen Oliver, Heanor Derbys (GB); Christopher John Webb, Dronfield Woodhouse (GB)

Correspondence Address: JohnsonDiversey Inc;Patent Section MS 509, 8310 16th Street, PO Box 902, Sturtevant, WI, 53177-4583, US

(21) Appl. No.: 10/510,537

(22) PCT Filed: Mar. 18, 2003
(86) PCT No.: PCT/US03/08492

§ 371 Date: Oct. 7, 2004

(30) Foreign Application Priority Data
Apr. 9, 2002 (EP) 02252522.4

(51) Int. Cl. B01F 5/04

(52) U.S. Cl. 137/888

(57) ABSTRACT

An eductor apparatus having an air gap and a venturi, a bypass channel and a spray protection device in the form of a deformable porous body to prevent splash back produced at the inlet to the venturi from escaping through the air gap. The spray protection device may also function to absorb the energy of a misaligned water jet and provide an emergency flow path.

### FIELD OF THE INVENTION

This invention relates to an eductor for mixing liquids, for example mixing a concentrated solution into a flow of water to provide a desired dilution of the concentrated solution.

### BACKGROUND OF THE INVENTION

It is common practice in many industries, such as the hotel and catering industries, for chemicals such as those used for cleaning to be purchased as concentrated liquids and then diluted with water to give the correct concentrations for use. Proportioning dispensing apparatus have been designed to achieve the desired dilution of the concentrated solution and dispense the mixed diluted solution.

These dispensers have commonly employed so-called venturi-type devices, known as eductors, to aspirate or draw the concentrated solution into the water stream.

In these eductors water travelling at a high velocity through a passage entrains the concentrated solution at a point where a restricted flow channel in the passage widens.

Since these dispensers are generally operated with water provided directly from the mains supply and it is important to maintain the water supply free of contamination, the eductors normally employ an air gap to prevent backflow of the chemicals into the water source.

Typically, air gap eductors operate in an upright arrangement, i.e. a water jet is directed vertically downwards, across an air gap and passes into the venturi where the concentrated liquid is entrained. Thus the eductor generally comprises a nozzle to generate the jet of water into the air gap located below the nozzle towards the venturi below the air gap. The venturi has an inlet located on an upper surface to receive the jet of water. Not all the water in the jet passes into the venturi inlet because the inlet usually has a smaller cross section than the jet. For example, a water jet with a diameter of 2-4 mm may be used with an inlet having a diameter of 1.5-1.8 mm. This helps to ensure that sufficient pressure is generated in the venturi. There is therefore a fraction of the water which will not pass directly into the venturi. This excess water must be collected from the top of the venturi and directed to the exit of the venturi. In most eductors there are bypass channels which enable this water to pass around the venturi structure and join the bulk of the water flow at the exit of the venturi. For example a bypass channel may be formed by providing an outer discharge tube around the venturi structure and spacing the outer discharge tube from the outer walls of the venturi to provide a throughflow space.

There are several drawbacks associated with known eductors. The jet of water created by the nozzle above the air gap will normally be a high velocity jet to ensure that sufficient velocity is generated in the inlet to the venturi. Thus, the fraction of water which is prevented from entering the venturi will contact the upper surfaces of the venturi with considerable force. This can generate large amounts of spray. The spray generated from these surfaces may be directed back into the air gap. This is undesirable because the air gap is normally open to the atmosphere and so the spray may settle on the outer surfaces of the eductor body or on nearby surfaces. If this water is not removed, it may become stagnant and result in the formation of microbial growth or hard water scale. The presence of water on the surfaces around the eductor also represents a potential slip hazard. In severe cases the spray can result in actual flow leakage out of the eductor.

Some eductors employ means to reduce splash back at the inlet to the venturi portion. WO94/04857 discloses an air gap eductor with a rigid disc having a central orifice located above the venturi section of the eductor.

U.S. Pat. No. 5,522,419 describes a spray shield located above the inlet to the venturi. The spray shield has sloping sides and extends from the bottom of the air gap to partially cover the inlet to the venturi.

U.S. Pat. No. 5,839,474 discloses an eductor having rib structures provided above the inlet to the venturi. Apparently these ribs assist in preventing splash back water from escaping into the air gap.

U.S. Pat. No. 5,862,829 describes an eductor having an overspray shield which fits over the tapered inlet of a venturi. The spray shield has a frustoconical configuration.

U.S. Pat. No. 5,673,725 discloses a water seal arrangement which comprises a narrow bore for the water jet to pass through and a recess in the lower surface of the seal. However, side splash may be generated with this arrangement and so drain holes are provided above the venturi to channel the side splash water past the venturi.

Thus, it is known to adapt air gap eductors to reduce the amount of spray that escapes into the air gap. However, a number of additional problems have been recognised by the present inventors which limit the effectiveness of eductors having known spray shield arrangements under a variety of operating conditions.

The water jet in air gap eductors may become misaligned during prolonged use, for example as a result of the build up of solids on the nozzle which generates the water jet. The water passing through the nozzle is typically heated to about 60° C. and so solids dissolved in the water may be precipitated at this elevated temperature. An example of a precipitate is lime scale. Dust and other deposits may also accumulate on the nozzle when the eductor is not in use. As a result, air gap eductors require regular maintenance.

### SUMMARY OF THE INVENTION

The present inventors have identified a particular problem associated with this phenomenon. A misaligned jet will not pass directly into the inlet of the venturi but will impact on the surfaces to either side of the venturi inlet. This will add significantly to the problem of splash back. This problem is greater in eductor arrangements having a spray shield which comprises a small orifice through which the water jet passes in normal use, for example those disclosed in WO 94/04857 and U.S. Pat. No. 5,522,419.

A further problem with known eductors has been identified by the inventors. Bypass channels provided to carry excess water from the upper surfaces of the venturi to the exit end of the venturi, may have insufficient capacity to deal with the large volumes of water encountered at high flow rates, in particular when the jet is misaligned. In most cases it is desirable to keep the size of the eductor to a minimum, and so simply providing a bypass channel with a larger cross section may not be viable.

Where the bypass channels are provided by a throughflow space between a venturi structure and an outer discharge tube, the inventors have found that back filling or backing up of water along the inner walls of the outer discharge tube can occur at high flow rates. This can lead to a build up of water at the inlet of the venturi, which will affect eductor performance and add to the splash back problem. Back filling can also cause water to escape via the air gap, which is undesirable for the reasons given above.

The present inventors have identified a further problem with the behaviour of the eductor in the situation where the outlet from the eductor becomes blocked. This may occur due to a build up of solids or chemical deposits on the outlet, or as a result of accidental restriction of the outlet path for example by crimping or crushing of a tube or pipe downstream of the outlet. In the event of a blockage at the outlet of the eductor during normal use there may be a build up of fluid pressure within the eductor. This pressure may be released by allowing the fluid to leave the eductor via the air gap. However, if there is insufficient fluid path from the venturi section to the air gap, for example where there is only a narrow orifice separating the venturi portion and the air gap, there may be a dangerous build up of pressure within the eductor. Ultimately, rupture of the eductor or uncontrolled release of water and concentrated liquid may occur. The inventors have perceived that an emergency fluid path from the venturi portion to the air gap is desirable in order to avoid over pressure in the eductor in the event of a blockage in the eductor outlet.

The present invention is based on an understanding of the structural features of eductors which give rise to the problems discussed above. The present invention addresses the drawbacks associated with known eductor arrangements and provides improvements in minimising spray and water leakage both under normal operation and in the situation where the water jet is misaligned. The present invention also addresses these problems in the situation where a blockage occurs in the outlet of the eductor.

It is an object of the present invention to provide splash back and water back fill protection whilst addressing the safety problems associated with jet misalignment and blockage of the eductor outlet.

Therefore, in a first aspect of the present invention there is provided an air gap eductor having an air gap, a venturi located below the air gap and a porous, preferably deformable, spray guard positioned between the air gap and an inlet to the venturi.

As used herein, porous means having pores extending through a body to provide throughflow fluid paths, for example via a series of interconnected cells. Examples of porous materials suitable for use in the present invention is are synthetic foams and woven and non-woven fabric structures.

The porous spray shield provides a high surface area on which moisture generated by splash back from the inlet to the venturi may be trapped and collected. In particular, the porosity improves the collection of fine mist generated at the inlet to the venturi. Where the eductor comprises a bypass channel, the spray guard may also trap and collect spray generated in the bypass channel.

A further advantage associated with using a deformable porous spray guard is the ability to safely disperse energy and water when the water jet is misaligned. When a misaligned water jet impacts on the deformable spray guard, a significant proportion of the energy of the jet may be absorbed by the spray guard, due to the deformation of the spray guard.

An additional advantage is found in the porosity of the spray guard, which allows flow of water through it when the high velocity jet impacts on a surface of the spray guard. Thus, when a jet is misaligned, the present invention provides a means of safely reducing splash back and an emergency water drain.

The present invention according to this aspect has a further advantage in that an emergency reverse flow route is provided through the spray guard in the event of a blockage in the outlet of the eductor. The porous nature of the spray guard allows a significant reverse flow of fluid through it in the situation where there is an overpressure in the venturi section. In other words fluid can pass from the venturi section to the air gap through the pores in the spray guard when an overpressure occurs in the venturi section. Furthermore, the deformable nature of the spray guard may allow an overpressure of fluid to escape easily even when the water jet is flowing.

The spray guard suitably has a central orifice through which the water jet can pass to the venturi. Suitably the spray guard is disc shaped. The size of the orifice may be chosen to slightly exceed the diameter of the water jet in a particular eductor. Preferably the only straight fluid path between the inlet of the venturi and the air gap is the orifice. This is desirable because it prevents spray, in particular fine spray, from passing up into the air gap during use.

The spray guard may be removable and/or interchangeable with other anti splash devices to allow the user to optimise the eductor arrangement or to allow cleaning of the spray guard.

An eductor of the present invention may comprise an outer discharge tube located around the venturi structure and extending above the venturi inlet. In this case, the spray guard of the present invention may be located within the outer discharge tube and above the venturi inlet. The outer discharge tube is suitably cylindrical in shape and in this case the spray guard may also have a cylindrical profile to allow intimate contact between the walls of the outer discharge tube and the spray guard. Such intimate contact is desirable because it prevents egress of spray into the air gap.

The dimensions of the spray guard depend on the size of the eductor to which it is applied. Normally, the width of the spray guard, i.e. in the direction perpendicular to the water jet direction, is no more than 100 mm. Preferably, the width of the spray guard is no more than 40 mm. The thickness of the spray guard, i.e. in the direction of water jet flow, may be selected depending on the shape and size of the rest of the eductor arrangement. It is also dependent on the material of construction of the spray guard since a material having a relatively low porosity should permit throughflow of water in the event of jet misalignment, as described above, and so it follows that there may be constraints on the maximum thickness of the spray guard. Conversely, where a material having a higher porosity is employed, the spray guard must have sufficient thickness to trap and collect back spray, particularly in the form of mist, and prevent it from passing through the spray guard. Preferably the spray guard has a thickness of not more than 50 mm, more preferably not more than 20 mm.

In a second aspect of the present invention there is provided an air gap eductor comprising an air gap, a nozzle above the air gap, a venturi portion having an inlet zone and a venturi, and a spray guard located above the venturi in the inlet zone, wherein the spray guard comprises an open central pathway permitting straight flow of a water jet from the nozzle to the venturi, and at least two vertically offset splash protection members arranged to provide a tortuous reverse flow path from below the spray guard to the air gap additional to the open central pathway.

This arrangement provides spray protection since there is no straight path between the venturi and the air gap, except the central pathway. The tortuous path through the members provides an emergency fluid path in the event of an overpressure in the venturi caused by blockage of the outlet to the eductor.

The spray guard may comprise at least two spaced apart vertically offset splash protection members, one located above and laterally spaced from the other, each member covering at least a part of the cross sectional area of the inlet zone, the vertical separation between the members providing a tortuous through flow path, such that all of the cross sectional area of the inlet zone, with the exception of the central pathway, is covered by the splash protection members.

The vertically offset splash protection members function as baffles within the inlet zone to prevent straight flow between the venturi and the air gap.

The spray guard may comprise three or more splash protection members, vertically offset with one laterally spaced from the others.

The spray guard may comprise overlapping members which further reduce the likelihood of spray passing into the air gap.

The spray guard may be removable and/or interchangeable with other anti splash devices to allow the user to optimise the eductor arrangement or to allow cleaning of the spray guard.

In a third aspect of the present invention there is provided an eductor comprising an air gap, a venturi structure having an inlet and an outlet, at least one bypass channel extending from the inlet to the outlet and open to the air gap, and a deflector element located in the bypass channel and projecting inwardly from an outer wall of the bypass channel and facing downwardly to deflect water flowing up the outer wall of the bypass channel.

This arrangement helps prevent back filling water on the outer wall of the bypass channel from escaping into the air gap by deflecting it back into the bypass channel. The arrangement also helps to prevent back filled water from interfering with the water jet as it enters the venturi.

In addition, this arrangement may also help to prevent splash back produced in the bypass channel from reaching the venturi inlet or the air gap.

The lower surface of the deflector which faces the lower part of the bypass channel may be horizontal, i.e. perpendicular to the downward water flow direction in the bypass channel. However, an additional advantage may be gained when the lower surface facing the inlet to the bypass channel is inclined downwardly from the outer wall of the bypass channel. The angle at which the deflector surface is inclined will depend on the geometry of the venturi and the bypass channel, but may be about 45° with respect to the through flow direction.

The deflector element may be provided by a removable body, for example a ring, which may be inserted into the eductor above the venturi.

In another aspect of the present invention there is provided an air gap eductor comprising a venturi structure and a bypass channel, wherein an inner wall of the bypass channel has a plurality of spaced grooves extending in the direction of through flow.

An advantage of this arrangement is that a reduction in back filling of the bypass channel can be achieved without changing the size or geometry of the eductor casing or outer discharge tube, i.e. without increasing the size of the bypass channel. The presence of the grooves has the effect of increasing the adhesion of water to the inner surface of the bypass channel and therefore directs the water away from the outer walls of the bypass channel and encourages direct throughflow in the bypass channel. This improves the efficiency of the bypass channel and increases the flow rate of water which can be accommodated. It is advantageous to direct the water away from the outer walls of the bypass filter because this can cause back filling of the bypass channel, as discussed above.

A further advantage is that spray may be reduced because a less turbulent water flow is generated in the bypass channel.

The grooves increase the surface area of the bypass channel inner wall surface compared with a surface in the absence of the grooves. The grooves may be of a width and depth such that water flowing across the surface comprising the grooves will be attracted to the surface by virtue of the surface tension of the water.

In a preferred arrangement the bypass channel is defined by the outer wall of the venturi structure and the inner wall of the outer discharge tube. In this arrangement the grooves are present on the outer surface of the venturi structure. The grooves extend from an upper portion of the venturi structure along a substantial part of the length of the venturi structure.

The preferred features of any one of the aspects of the present invention may be applied to any of the other aspects. Any one of the aspects of the present invention may be put into practice singularly or in combination with any of the other aspects to achieve cumulative improvements in splash back protection and safety performance.

### BRIEF DESCRIPTION OF THE DRAWINGS

The invention will now be described by way of example only with reference to the accompanying drawings in which:

FIG. 1A is a cutaway perspective view of an eductor according to the first aspect of the present invention;

FIG. 1B is an enlarged view of the ringed portion of FIG. 1A;

FIG. 2A is a cutaway perspective view of an eductor according to the second aspect of the present invention;

FIG. 2B is an enlarged view of the ringed portion of FIG. 2A;

FIG. 3A is a cutaway perspective view of an eductor according to the third aspect of the present invention;

FIG. 3B is an enlarged view of the ringed portion of FIG. 3A;

FIG. 4A is a cutaway perspective view of another eductor according to the present invention;

FIG. 4B shows a vertical cross section of part of the eductor of FIG. 4A;

FIG. 4C is an enlarged view of the ringed portion of FIG. 4A;

FIG. 5A is a cutaway perspective view of an eductor according to a further aspect of the present invention; and

FIG. 5B is an enlarged view of the ringed portion of FIG. 5A.

### DETAILED DESCRIPTION OF EMBODIMENTS

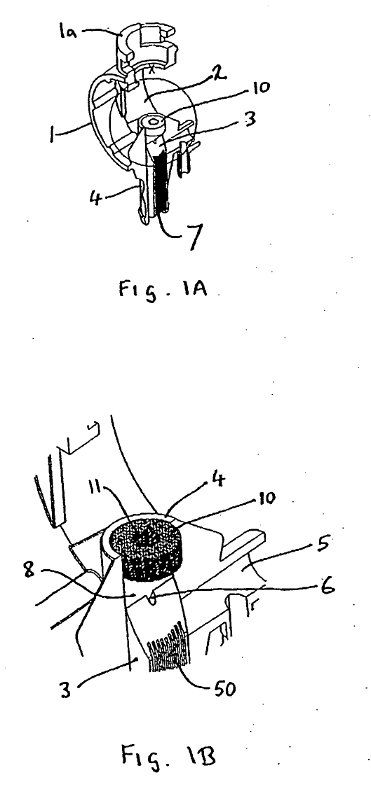

In each of FIGS. 1 to 5 there is shown an air gap type eductor formed mainly of molded plastics material components. Each figure is cut away mainly at the central vertical and axial plane of the eductor. The air gap 2 is provided by an open-ended cylindrical barrel 1, above which is a housing 1a for a nozzle (not shown) which provides in use a vertically downward jet of water (not shown). The nozzle can be of conventional construction and is not shown here.

At the lower side of the air gap 2 is a discharge tube 4 having the venturi structure 3 mounted within and extending diagonally across it so as to leave bypass channels 8 on both sides (only one bypass channel 8 is to be seen in the figures), defined by the outer wall of the venturi structure 3 and the inner wall of the discharge passage 4. The venturi passage has an inlet 6 at the centre of a knife-like ridge at the top of the venturi structure 3, below the level of the opening of the discharge passage 4. The interior of the venturi structure 3 is conventional and need not be described.

A side passage 5 in the venturi structure is for the flow of the liquid to be entrained into the water flow. At its lower end, the passage through the venturi 3 rejoins the bypass channels 8.

The eductor 1 in the embodiment of FIGS. 1A and 1B comprises a disc shaped spray guard 10 made from a porous foamed polymeric material, located within the discharge tube 4, above the venturi inlet 6. The spray guard 4 has a central orifice 11 for passage of the water jet during use. During normal operation, the water jet passes vertical downwards across the air gap 2, through the central orifice 11 in the spray guard 10 and enters the venturi inlet 6. Inside the venturi a concentrated chemical delivered via the side inlet 5 is entrained in the water flow and a dilute mixed solution leaves the eductor at the venturi exit 7.

The orifice 11 in the spray guard 10 has a diameter slightly larger than the diameter of the water jet. Splash back caused by the water jet striking the upper surfaces of the eductor near the inlet 6 is hindered from escaping into the air gap 2 by the spray guard 10. The porous nature of the spray guard allows the spray guard to effectively trap and collect spray, in particular fine mist, generated in the discharge tube 4.

As described above, the spray guard 10 allows a reverse flow of water to the air gap from the bypass channels 8 and/or the venturi 3, if a back pressure is generated. This avoids build up of excessive back pressure. The porous nature and deformability of the spray guard also minimizes splash back from it if it is hit by a misaligned water jet crossing the air gap 2 from the nozzle above.

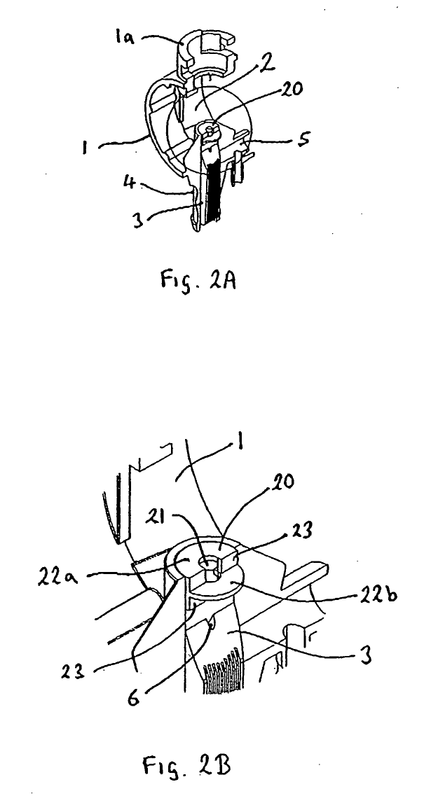

FIGS. 2A and 2B illustrate an embodiment in which the spray guard 20 comprises a removable moulded plastics body having three offset baffles in the form of semicircular flat plate-like members 22a, 22b vertically spaced from one another. The upper two members 22a and 22b as can be seen are each horizontal, with cut outs at their axes, and extend inwardly from opposite sides of the discharge tube 4 to a diametrical vertical plane at which they are joined by vertical walls 23. The third baffle is not seen in the figures but is at the lower end of the guard 20 and is of the same shape and location in plan view as the upper member 22a and is joined to the middle member 22b by the vertical walls 23. The three offset, or staggered, semicircular members as seen in plan view cover the entire cross section of the outer discharge tube 4, except at a straight central path 21 extending axially through the spray guard 20 for the water jet. The path 21 is the only straight path between the air gap 2 and the venturi 3. In use, the lower surfaces of the three semicircular members collect spray and mist generated at the venturi inlet 6 and redirect it back into the outer discharge tube 4, away from the air gap 2.

The three baffles, described above, of the spray guard 20 define a tortuous or zigzag path for reverse flow of water from below the guard 20 to the air gap 2, this path coinciding with the straight path 21 at the central axis. This reverse flow path permits back flow of water, to relieve back pressure, as described above, even during flow of the downward water jet.

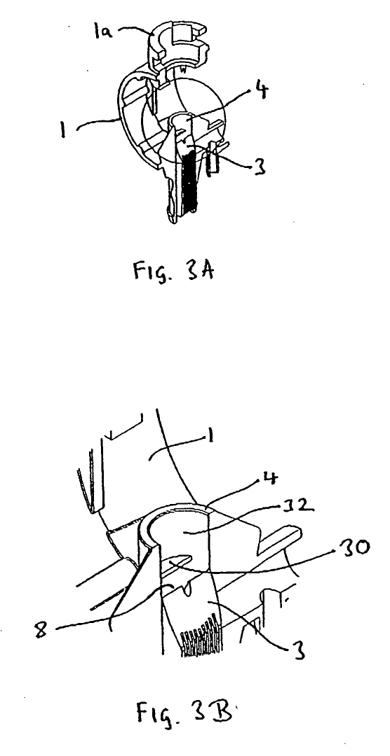

FIGS. 3A and 3B illustrate another embodiment of the present invention in which a sector-shaped horizontal shelf or ledge 30 is provided on the discharge tube, directly above each bypass channel 8. The ledge 30 extends from the inner wall 32 of the discharge tube 4 part way to the vertical mid-plane and in use acts to deflect any back fill water that tends to pass up the tube 4 in the bypass channel 8 to reduce the possibility that such water reaches from the air gap 2. In this embodiment the ledge 30 forms an integral part of the discharge tube 4 and may be formed by moulding in one-piece with the outer discharge tube.

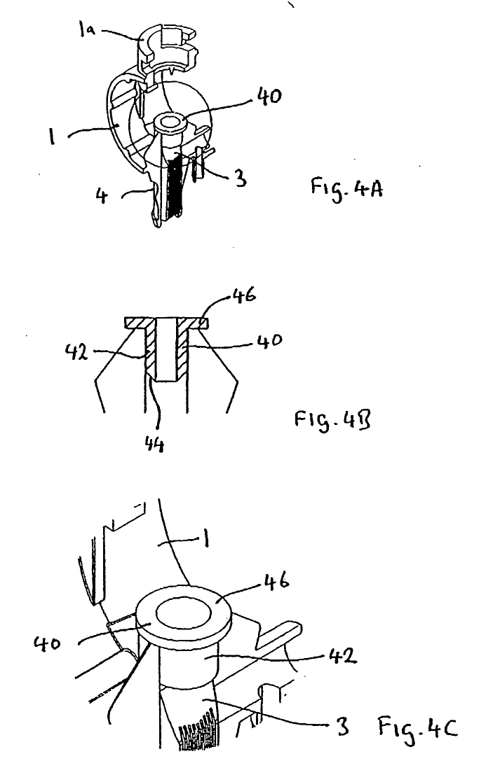

FIGS. 4A, 4B and 4C illustrate a further embodiment intended to achieve a similar effect to that of FIG. 3. A removable deflector ring 40 having a ‘top hat’ profile is located as a sliding fit within the discharge tube 4 above the venturi inlet 6. The deflector ring comprises a cylindrical ring portion 42 with an oblique annular lower surface 44 and a collar portion 46 for locating it at the entrance to the discharge tube 4. The lower surface 44 is above the level of the top of the venturi structure 3 and, as seen in axial section slopes downwardly away from the wall of the tube 4.

In use, the inclined lower surface 44 acts to redirect water that has back filled from the bypass channels downwardly and towards the centre of the tube 4. This helps prevent such water from escaping into the air gap or interfering with the water jet.

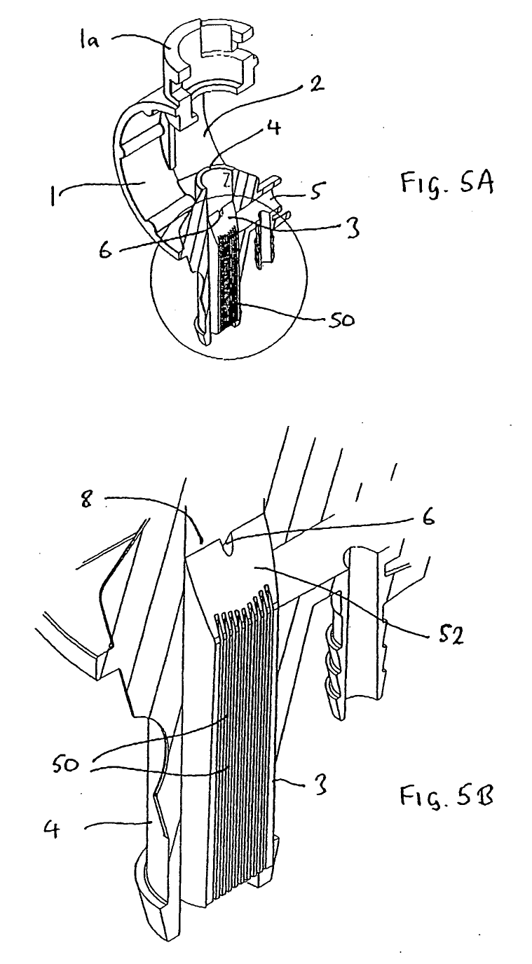

FIGS. 5A and 5B show more detail of the feature common to all the illustrated embodiments of the present invention, in which the venturi structure 3 has on both sides nine parallel vertical grooves 50 extending from a lower part of its top wedge portion 52 to its bottom. These grooves are narrower in width then depth, and face the bypass channels 8. Their effect is to increase the amount of water that flows (upwardly or downwardly) on the inner face of the bypass channel, thus particularly decreasing the amount which may flow upwardly, due to back-filling, on the inner wall of the tube 4. This reduces the risk that back filling water may reach the air gap 2.

1. An air gap eductor having an air gap, a venturi located below the air gap and a porous spray guard positioned between the air gap and an inlet to the venturi.

2. An air gap according to claim 1, wherein the spray guard comprises a central orifice.

3. An air gap eductor according to claim 1, wherein the spray guard is disc shaped.

4. An air gap eductor according to claim 1, wherein the spray guard is made from a deformable material.

5. An air gap eductor according to claim 1, wherein the spray guard is removable.

6. An air gap eductor comprising an air gap, a nozzle above the air gap, a venturi portion having an inlet zone and a venturi, and a spray guard located above said venturi in said inlet zone, wherein the spray guard comprises an open central pathway permitting straight flow of a water jet from the nozzle to the venturi, at least two vertically offset splash protection members arranged to provide a tortuous reverse flow path from below the spray guard to the air gap additional to said open central pathway.

7. An air gap eductor according to claim 6, wherein the spray guard comprises three mutually vertically offset splash protection members, the middle one of which is laterally staggered with respect to the upper and lower ones to define said tortuous path.

8. An air gap eductor according to claim 6, wherein the splash protection members are each a semicircular disc having an axial cut out to define said open central pathway.

9. An eductor comprising an air gap, a venturi structure having an inlet and an outlet, at least one bypass channel extending from the inlet to the outlet and open to the air gap, and a deflector element located in the bypass channel and projecting inwardly from an outer wall of the bypass channel and facing downwardly to deflect water flowing up the outer wall of the bypass channel.

10. An air gap eductor according to claim 9, wherein the deflector element is removable.

11. An air gap eductor according to claim 9 or claim 10, wherein the deflector element comprises a ledge made in one piece with the bypass channel.

12. An air gap eductor according to claim 9, wherein the lower surface of the deflector element is downwardly sloping away from the outer wall of the bypass channel.

13. An air gap eductor comprising a venturi structure and a bypass channel for flow bypassing the venturi, wherein an inner wall of the bypass channel comprises a plurality of spaced grooves extending in the direction of through flow.

14. An air gap eductor according to claim 2, wherein the spray guard is disc shaped.

15. An air gap eductor according to claim 2, wherein the spray guard is made from a deformable material.

16. An air gap eductor according to claim 3, wherein the spray guard is made from a deformable material.

17. An air gap eductor according to claim 2, wherein the spray guard is removable.

18. An air gap eductor according to claim 3, wherein the spray guard is removable.

19. An air gap eductor according to claim 4, wherein the spray guard is removable.

20. An air gap eductor according to claim 7, wherein the splash protection members are each a semicircular disc having an axial cut out to define said open central pathway.

21. An air gap eductor according to claim 10, wherein the deflector element comprises a ledge made in one piece with the bypass channel.

22. An air gap eductor according to claim 10, wherein the lower surface of the deflector element is downwardly sloping away from the outer wall of the bypass channel.

23. An air gap eductor according to claim 11, wherein the lower surface of the deflector element is downwardly sloping away from the outer wall of the bypass channel.
